(19) United States
(12) Patent Application Publication
(10) Pub. No.: US 2015/0100825 A1
(43) Pub. Date: Apr. 9, 2015

(54) INFORMATION PROCESSING DEVICE AND METHOD

(71) Applicant: FUJITSU LIMITED, Kawasaki-shi (JP)

(72) Inventors: Masayuki JIBU, Kawasaki (JP); Atsushi OHASHI, Yokohama (JP); Yusuke SHIMIZU, Shibuya (JP); Takeharu KANEKO, Setagaya (JP); Kazuhide IMAEDA, Kawasaki (JP); Yasutoshi SUZUKI, Inagi (JP); Hiroyuki YAMAMOTO, Kawasaki (JP)

(21) Appl. No.: 14/571,724

(22) Filed: Dec. 16, 2014

Related U.S. Application Data
(63) Continuation of application No. PCT/JP2012/067015, filed on Jul. 3, 2012.

(51) Int. Cl. G06F 11/14

(52) U.S. Cl. CPC G06F 11/1441
USPC 714/23

(57) ABSTRACT

An information processing device includes a processor that performs a process. The process includes: when the information stored in the first storage unit is stored in the second storage unit, storing the storing completion information corresponding to the stored information in the storing completion information storing unit; detecting a failure in the information processing device; performing a restart process on the information processing device using a region in which the stored information has been stored in the first storage unit on the basis of the storing completion information when the failure is detected; and discriminating information that has not been stored in the second storage unit from among the pieces of information stored in the first storage unit on the basis of the storing completion information when the failure is detected, and storing the discriminated information in the second storage unit.

This application is a continuation application of International Application PCT/JP2012/067015 filed on Jul. 3, 2012 and designated the U.S., the entire contents of which are incorporated herein by reference.

### FIELD

The embodiments discussed herein are related to a memory dump method, and a system that performs the memory dump method.

### BACKGROUND

When it is judged that a system is no longer able to run due to a serious system failure, an operating system (hereinafter sometimes referred to as an “OS”) stores the contents of physical memory that is installed in the system in an auxiliary storage device in order to investigate the cause of the system failure. In other words, a processor that has reported an error executes a program for dump output, and writes the contents of the physical memory to a file on a disk. After writing to the disk is finished, the system sequentially starts the OS and a program running on the OS through a usual restart process, and re-operates the system.

A time needed to re-operate a system increases as a capacity of memory that is installed in the system increases. This is because a time needed for writing to a disk when dumping memory increases in proportion to a mounted memory capacity. A system in which high availability is needed does not tolerate a time needed for restarting when dumping memory, and therefore a memory dump fails to be obtained, and a failure investigation is not performed.

As a method for shortening a dump time, a method is known in which, when a system failure occurs, the contents of memory in an OS core portion that uses a specific region in physical memory are dumped, a physical memory region, which is the OS core portion, is released, and the OS core portion is re-loaded in a corresponding memory region. In this method, a table for managing a dump obtaining status is used. In addition, after starting the OS, a dump obtaining process is performed with a lowest priority on a region that has not been dumped. Further, in executing a program after starting the OS, when a memory page that is used in the program has not been dumped, the memory page is dumped, and is used in the program.

Note that technologies are known that are described in, for example, Japanese Laid-open Patent Publication No. 10-333944, Japanese Laid-open Patent Publication No. 2000-293391, Japanese Laid-open Patent Publication No. 2009-140293, and the like.

### SUMMARY

According to an aspect of the embodiment, an information processing device includes a first storage unit, a second storage unit, a storing completion information storing unit, and a processor. The first storage unit stores pieces of information that the information processing device uses. The second storage unit stores pieces of information stored in the first storage unit. The storing completion information storing unit stores storing completion information that discriminates information that has been stored in the second storage unit from among the pieces of information stored in the first storage unit. The processor executes a process including: when the information stored in the first storage unit is stored in the second storage unit, storing the storing completion information corresponding to the stored information in the storing completion information storing unit; detecting a failure in the information processing device; performing a restart process on the information processing device using a region in which the stored information has been stored in the first storage unit on the basis of the storing completion information when the failure is detected; and discriminating information that has not been stored in the second storage unit from among the pieces of information stored in the first storage unit on the basis of the storing completion information when the failure is detected, and storing the discriminated information in the second storage unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 illustrates an example of a functional block diagram of an information processing device according to an embodiment.

FIG. 2 illustrates an example of a configuration of an information processing device according to the embodiment.

FIG. 3 illustrates an example of a configuration of a memory management table according to the embodiment.

FIG. 4 illustrates an example of file arrangement of physical memory when starting a system according to the embodiment.

FIG. 5 illustrates a process flow during OS operation.

FIG. 6 illustrates a process flow at the time of the occurrence of a serious error.

FIG. 7 is a diagram explaining operations of a memory managing unit and a memory management table when a memory page is updated.

FIG. 8 is a diagram explaining that addresses in a page address field of a memory management table according to the embodiment correspond to memory pages of physical memory.

FIG. 9 illustrates a state of a memory management table when performing a memory full dump, which is performed immediately after starting an OS when starting operation of a system according to the embodiment.

FIG. 10 illustrates a state of a memory management table when updating a memory page.

FIG. 11 illustrates an operation flow of a system when outputting a differential dump during OS operation.

FIG. 12 illustrates an operation flow of rearrangement of physical memory according to an update frequency of a memory page.

FIG. 13 illustrates an operation flow of a system after a serious error occurs in a server but before OS start-up is completed.

FIG. 14 illustrates an operation flow of a system when dumping a memory page that has not been dumped, with multiprocessing after OS start-up.

FIG. 15 illustrates an example of a hardware configuration of an information processing device according to the embodiment.

### DESCRIPTION OF EMBODIMENTS

When a serious system failure occurs and it takes time to dump the contents of memory in an OS core portion to a disk after the failure occurs, it takes a long time to re-operate the system. In this case, a service is not restarted until all of the contents of a memory region used by the service are dumped.

An information processing system according to the embodiment enables shortening a dump time needed for system recovery when a failure occurs in the system.

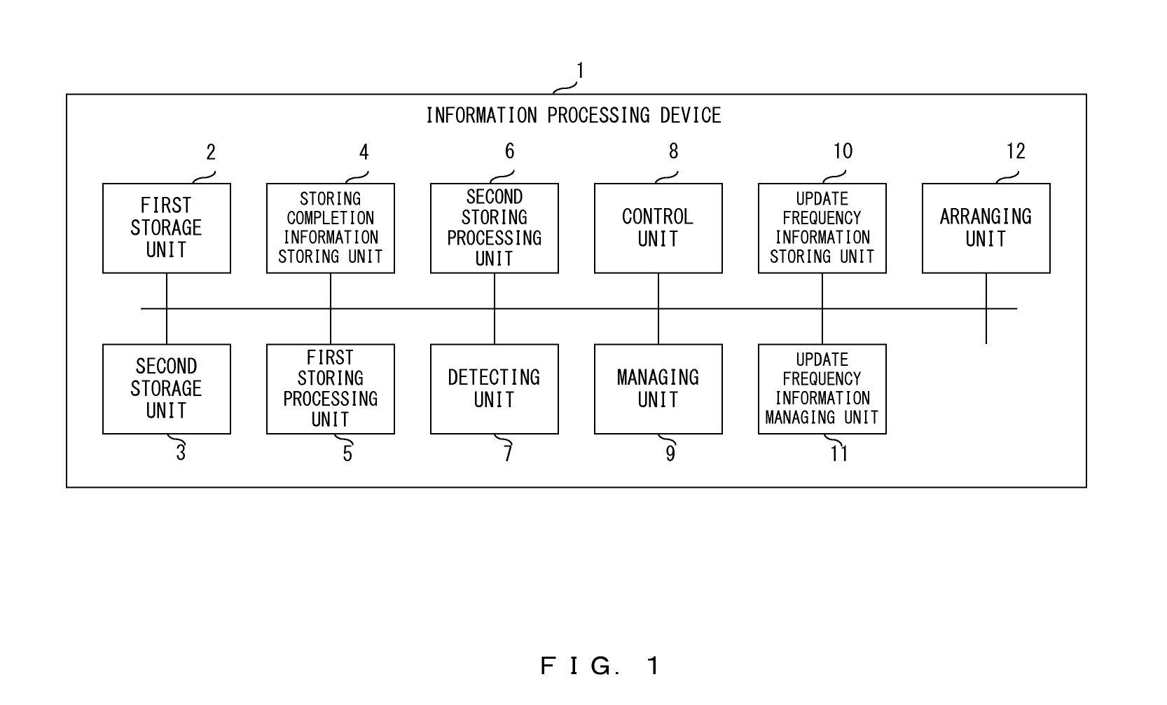

FIG. 1 illustrates an example of a functional block diagram of an information processing device according to the embodiment.

An information processing device 1 includes a first storage unit 2, a second storage unit 3, a storing completion information storing unit 4, a first storing processing unit 5, a second storing processing unit 6, a detecting unit 7, a control unit 8, a managing unit 9, an update frequency information storing unit 10, an update frequency information managing unit 11, and an arranging unit 12.

The first storage unit 2 stores information used by the information processing device 1.

The second storage unit 3 stores information stored in the first storage unit 2.

The storing completion information storing unit 4 stores storing completion information that discriminates information that has been stored in the second storage unit 3 from among pieces of information that were stored in the first storage unit 2.

When information stored in the first storage unit 2 is stored in the second storage unit 3, the first storing processing unit 5 stores storing completion information corresponding to the stored information in the storing completion information storing unit 4. In addition, the first storing processing unit 5 stores, in the second storage unit 3, information that has not been stored in the second storage unit 3 from among pieces of information that were stored in the first storage unit 2, on the basis of the storing completion information at prescribed time intervals.

When a failure occurs in the information processing device 1, the second storing processing unit 6 discriminates information that has not been stored in the second storage unit 3 from among pieces of information that were stored in the first storage unit 2, on the basis of the storing completion information, and stores the discriminated information in the second storage unit 3.

The detecting unit 7 detects a failure in the information processing device 1.

When the detecting unit 7 detects a failure, the control unit 8 performs a restart process on the information processing device 1 on the basis of the storing completion information, using a storage region in the first storage unit 2 in which information that has been stored in the second storage unit 3 was stored.

When information stored in the first storage unit 2 is updated, the managing unit 9 stores storing completion information corresponding to the updated information in the storing completion information storing unit 4.

The update frequency information storing unit 10 stores update frequency information indicating an update frequency for each of the storage regions included in the first storage unit 2. Information that has been stored in a storage region that has a value of update frequency information that is not more than a prescribed threshold value is stored in the second storage unit 3 by the first storing processing unit 5, and storing completion information corresponding to the stored information is stored in the storing completion information storing unit 10 by the first storing processing unit 5.

When information stored in the first storage unit 2 is updated, the update frequency information managing unit 11 updates update frequency information corresponding to a storage region in which the updated information has been stored.

In accordance with the update frequency information, the arranging unit 12 moves the information stored in the storage region to a storage region in the first storage unit 2 that corresponds to the update frequency information.

The configuration above allows as many regions as possible from among an OS region and memory regions used by other services (applications) to enter into a dumped state during system operation. As a result, a memory dump amount that is obtained after failure occurrence (an amount written to a file) is minimized. In addition, when a failure occurs, an OS restart process is started using a dumped region. This enables starting a restart immediately after a failure occurs, without providing a time needed for a dump process. Further, for a region that has not been dumped when a failure occurs, the contents of memory are not released but are stored even after restarting the OS, and the region that has not been dumped is dumped after restarting the OS. This enables obtaining the contents of memory at the time of failure occurrence in a complete state.

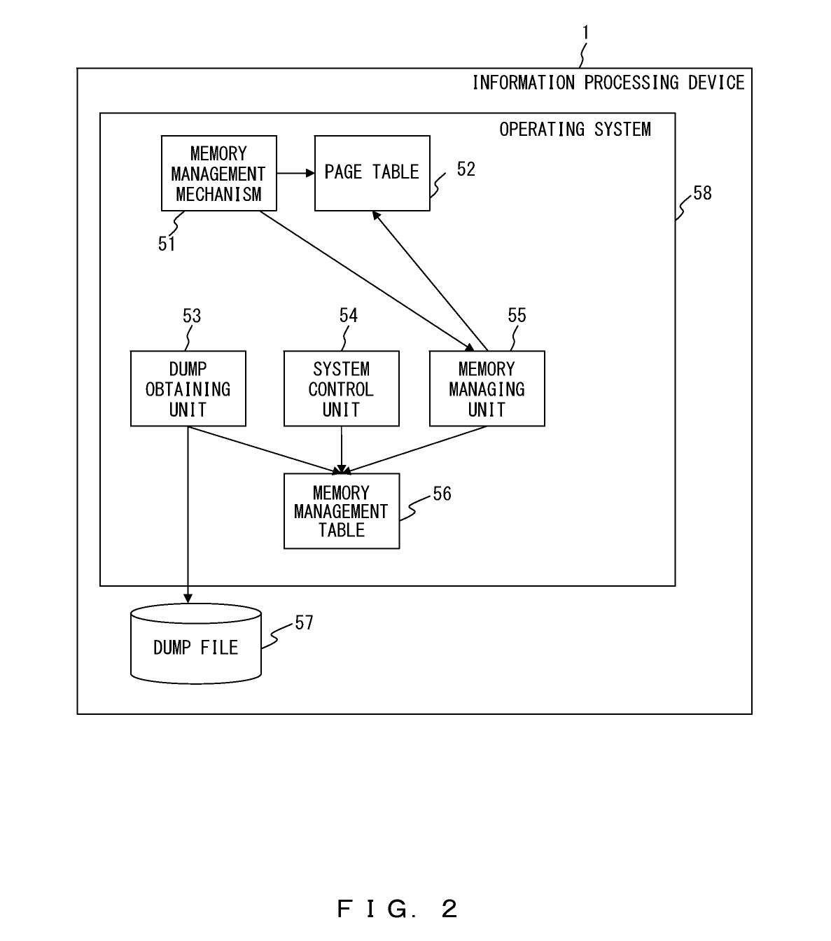

FIG. 2 illustrates an example of a configuration of the information processing device 1 according to the embodiment.

In the information processing device 1, an operating system 58 is executed. The operating system 58 has functions of a memory management mechanism 51, a page table 52, a dump obtaining unit 53, a system control unit 54, a memory managing unit 55, and a memory management table 56. In addition, the information processing device 1 stores a dump file 57.

The dump obtaining unit 53 is given as an example of the first storing processing unit 5 or the second storing processing unit 6. The system control unit 54 is given as an example of the control unit 8. The memory managing unit 55 is given as an example of the managing unit 9, the update frequency information managing unit 11, or the arranging unit 12. Information in the memory management table 56 is given as an example of storing completion information stored in the storing completion information storing unit 4 or update frequency information stored in the update frequency information storing unit 10.

The dump obtaining unit 53, the system control unit 54, and the memory managing unit 55 may be realized as applications executed on the operating system 58, or may be realized as modules executed in the operating system 58. Further, the dump obtaining unit 53, the system control unit 54, and the memory managing unit 55 may be realized as software executed separately from the operating system 58.

The operating system 58 is an OS executed in the information processing device 1.

The memory management mechanism 51 performs address conversion between a virtual address and a physical address of the information processing device 1, using the page table 52. The page table 52 is a table in which mapping information is stored that is obtained by performing mapping between a virtual address and a physical address of the information processing device 1.

The dump obtaining unit 53 outputs a full dump of memory, and a differential dump from a previously obtained dump that is obtained at a prescribed timing, during OS operation. A memory dump is obtained appropriately during OS operation so as to reduce a memory capacity that needs to be dumped at the time of failure occurrence.

A function of performing full dumping of memory during OS operation is a function of outputting, to an auxiliary storage device, the contents of all regions in physical memory in the form of the dump file 57 while the OS is running. A full dump of memory is performed when operation of a system according to the embodiment is started.

A function of outputting a differential dump during OS operation is a function of outputting, to the dump file 57 on a disk, update contents of only memory regions that have been updated after a dump was obtained previously. Differential dumping is performed at prescribed time intervals. A timing of obtaining a differential dump can be set by a user by using a parameter.

An update process on a dump file 57 is performed by overwriting a previously obtained dump file 57 with differential contents so as to perform updating. Alternatively, an update process on the dump file 57 may be performed by storing differential contents in a file other than a previously obtained dump file 57 and merging a differential file with the dump file 57 afterward.

A memory region on which differential dumping is performed is determined by the dump obtaining unit 53 by using the memory management table 56 that manages an update state of physical memory. The memory management table 56 and an operation of determining a region on which differential dumping is performed by using the memory management table 56 are described later.

Further, the dump obtaining unit 53 dumps a memory page that has not been dumped after a failure occurs and the OS is restarted. The dump obtaining unit 53 has a function of speeding up a dump process by performing the dump process with multi-threading. This function enables performing a dump process with multiprocessing so as to perform the dump process in a short time. Multi-threading refers to performing processes in parallel using a plurality of threads. Details of the process are described later.

Next, the memory management table 56 is described. The memory management table 56 manages an update frequency of a memory page and whether a memory page has been dumped, for each of the memory pages configuring physical memory.

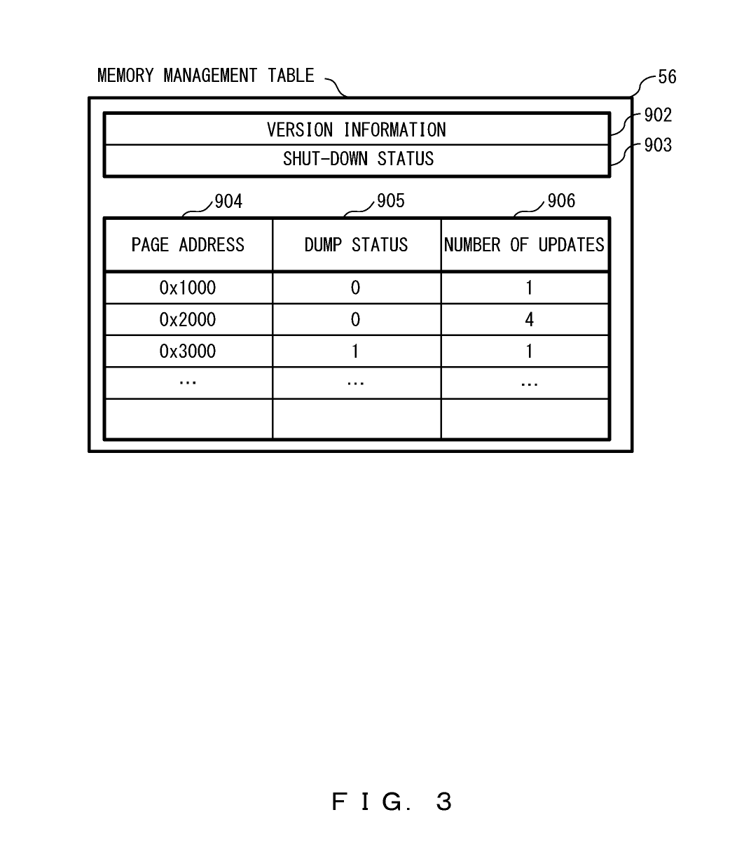

FIG. 3 illustrates an example of a configuration of the memory management table 56 according to the embodiment. The memory management table 56 includes fields “version information” 902 and “shut-down status” 903 as management information. In addition, the memory management table 56 includes data items “page address” 904, “dump status” 905, and “number of updates” 906.

“Version information” 902 is a field for managing a version of the memory management table 56.

“Shut-down status” 903 indicates whether a previous shut-down was performed normally. In this field, when a previous shut-down was performed normally, for example, “1” is stored. When a previous shut-down was not performed normally due to the occurrence of a failure or the like, for example, “0” is stored.

“Page address” 904 indicates an address of each of the memory pages configuring physical memory. “Page address” 904 is associated with each of the pages of the physical memory. “Dump status” 905 indicates whether the current contents of physical memory having an address indicated by “page address” 904 have been dumped. “Number of updates” 906 indicates how many times physical memory having an address indicated by “page address” 904 has been updated. The number of updates is the number of updates in a time period from a time prescribed as a reference to the present time.

When the current contents of a memory page have been dumped, for example, “1” is stored in “dump status” 905. When the current contents of a memory page have not been dumped, for example, “0” is stored. A value of “dump status” 905 is rewritten when a memory page is dumped, or when writing (updating) is performed on a memory page. When a memory page is dumped, for example, “1” is written in “dump status” 905 of the dumped memory page. When writing (updating) is performed on a memory page, for example, “0” is written in “dump status” 905 of the memory page on which writing was performed.

When writing (updating) is performed on a memory page, a value of “number of updates” 906 for the memory page is incremented by “1”.

FIG. 3 illustrates an entry in which the value of “page address” 904 is “0x1000”, the value of “dump status” 905 is “0”, which means that a dump has not been obtained, and the value of “number of updates” 906 is “1”, which means a region that has been updated once in a time period from a previous full-dump time to the present time.

The system control unit 54 has a function of releasing a dumped memory page on the basis of the memory management table 56, and of starting a system using only a region of the released memory page when a serious error occurs in a server. This function enables immediately starting a restart process on the system without needing a time to obtain a memory dump when a failure occurs. Here, the system is restarted while the memory contents of a memory page that has not been dumped are not cleared but the memory contents at the time of the occurrence of a failure are kept. Therefore, the contents of memory that has not been dumped can be obtained even after a restart, and the memory contents at the time of the occurrence of a failure can be stored in a complete state.

Memory needed to start a system is secured from a region that has been dumped, during OS operation before the occurrence of a failure. As described above, the memory management table 56 manages whether regions have been dumped. Therefore, the system control unit 54 refers to the memory management table 56 so as to determine a dumped region.

When a region needed for start-up exceptionally fails to be secured, that is, when a capacity of a dumped region is less than a capacity needed to start the OS, the dump obtaining unit 53 continues to perform dumping until a region needed for start-up is secured. Then, the system control unit 54 waits until a region needed to start the OS is secured, and starts a restart process.

In addition, the system control unit 54 has a function of inheriting a memory management table 56 during OS operation before the occurrence of a failure even after the OS is restarted. This function enables dumping only memory pages that have not been dumped after the OS is restarted, and efficiently generating a complete dump file 57 at the time of the occurrence of a failure. In addition, this function enables sequentially allocating memory pages in dumped regions as memory pages that an application program newly needs after the OS is restarted.

Next, the memory managing unit 55 is described. The memory managing unit 55 has a function of rearranging physical memory in accordance with update frequencies of memory pages. In other words, physical memory is divided into continuous regions for each update frequency, and the contents of the memory pages configuring the physical memory are moved between the divided regions in accordance with update frequencies of the memory pages. As described above, physical memory is configured as continuous regions that have been classified according to respective update frequencies so as to improve the utilization efficiency of memory in a memory dump process and a restart process.

Physical memory is divided into three continuous regions. A size in each of the regions is determined for each fixed region size, and the region size is assumed to be given in advance by a user, using a parameter or the like. In the description below, the three divided memory regions are referred to as “memory region 1”, “memory region 2”, and “memory region 3” in ascending order of physical addresses of the regions. Here, a lower address refers to an address having a small value, and an upper address refers to an address having a large value.

The three continuous regions are controlled by the memory managing unit 55 such that each of the three continuous regions is configured by memory pages that have almost the same update frequency. In other words, the three continuous regions are controlled so as to be a memory region that is configured by memory pages having a high update frequency, a memory region that is configured by memory pages having a middle-level update frequency, and a memory region that is configured by memory pages having a low update frequency, respectively. A control method is described later.

According to the embodiment, memory region 1, which is located in a region having a lower physical address, corresponds to a memory region having a low update frequency. Here, the region having a low update frequency includes a writing-inhibited region in which updating is not performed. Memory region 3, which is located in a region having an upper physical address, corresponds to a memory region having a high update frequency. Memory region 2, which is located in a region having a middle-level physical address between memory region 1 and memory region 3, corresponds to a memory region having a middle-level update frequency.

The memory managing unit 55 classifies memory pages in physical memory in accordance with update frequencies of the memory pages at every prescribed time. Then, the memory managing unit 55 moves the memory pages to respective memory regions (memory region 1, memory region 2, and memory region 3) that correspond to update frequencies according to which the memory pages have been classified. A threshold value is used for classification according to an update frequency. The threshold value can be changed by a system user, using a parameter. In addition, the threshold value can be set flexibly, and can be set using a parameter for a system load or the like.

Images or the like when starting a system and when starting a service application are classified in accordance with usage, and are arranged in three regions. In other words, the memory managing unit 55 classifies a module that serves as the core of an OS, a read-only code region and the like as “low update frequency”, and arranges them in memory region 1. The memory managing unit 55 classifies a usage region having a high update frequency or the like as “high update frequency”, and arranges the region in memory region 3. As an example, a read-only region that is not usually updated until the next restart is loaded in memory region 1 when starting a server. Examples of a read-only region include, for example, an OS kernel, a device driver needed to operate a system, and the like.

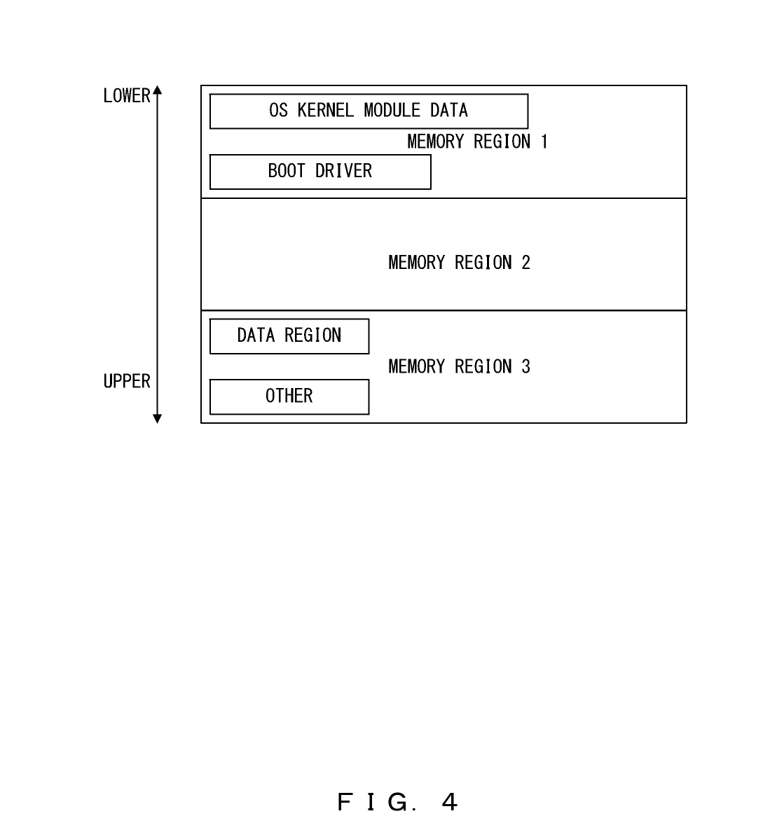

FIG. 4 illustrates an example of file arrangement of physical memory when starting a system according to the embodiment. In the example of FIG. 4, memory region 1, which is located in a lower address region and corresponds to a low update frequency, includes regions of OS kernel module data and a boot driver. Memory region 3, which is located in an upper address region and corresponds to a high update frequency, includes a data region and another region.

After memory pages are arranged in accordance with the above rule when starting the system, the memory managing unit 55 periodically checks a memory writing frequency using the memory management table 56, and moves the contents of the memory pages in accordance with update frequencies. Specifically, a threshold value used for classification according to an update frequency is preset, and the memory managing unit 55 moves a page having an update frequency that is higher than the threshold value to a one-rank-higher region and moves a page having an update frequency that is lower than the threshold value to a one-rank-lower region. As an example, when the memory managing unit 55 checks a writing frequency for a memory page that is located in memory region 2 and discovers that the writing frequency is higher than the threshold frequency, the memory managing unit 55 moves the memory page to memory region 3. Movement of a memory page by the memory managing unit 55 may be performed by reproducing the contents of memory. Here, the memory managing unit 55 does not perform movement when the memory managing unit 55 judges that it is impossible to move the contents of memory for some reason.

When the memory managing unit 55 moves the contents of a memory page, mapping between a physical address and a virtual address that is managed by the OS is changed. Then, the memory managing unit 55 updates the page table 52 of the system after completing movement of the memory page. In other words, the memory managing unit 55 changes a physical address corresponding to a virtual address of memory to be moved from a physical address before the movement to a physical address after the movement in the page table 52, and updates mapping between the virtual address and the physical address. Accordingly, operation of an application does not need to be changed following a memory rearrangement operation.

A memory rearrangement function may be implemented so as to be linked with a platform (hardware hypervisor).

By rearranging memory as described above, memory dump information during operation and memory generated after restart can be combined at high speed, and a time needed to generate a memory dump after the occurrence of a failure can be shortened. Here, it is highly likely that contents in memory region 1 corresponding to a low update frequency have already been dumped, and a restart is performed using a dumped region. Therefore, if regions having low update frequencies are continuously secured in regions having lower addresses, memory can be used efficiently when starting a system. Regions having low update frequencies are arranged in a lower side of physical memory, because a memory dump is performed from a region having a lower address and this arrangement results in improving the efficiency of a memory dump.

Next, a process flow of a system according to the embodiment is described.

Before starting operation of a system according to the embodiment, the dump obtaining unit 53 stores, in a disk, the contents of all of the regions in memory in the form of the dump file 57 immediately after an OS is started. In the subsequent regular operation, differential updating is performed on the dump file 57 for only updated memory regions at an arbitrary timing. When the dump file 57 is updated after all memory updates, a load on the system for a dump process is increased, and therefore differential updating is not performed for memory regions having high update frequencies. In addition, the memory management table 56 manages an update frequency of a memory region and whether the region has been dumped.

When a failure occurs, the system is restarted. For a region used for a restart, a region for which a memory dump has been obtained at the time of the occurrence of the failure is used. A memory region that has not been dumped is inherited in a state in which the contents at the time of the occurrence of the failure are held unchanged, even after the restart (in other words, the memory region is not cleared). Even if a memory region in which the memory management table 56 has been stored has already been dumped, information of the memory management table 56 at the time of a previous operation is not used for a restart process, and the contents of the information are inherited even after the restart. A region that has not been dumped is dumped after a restart on the basis of information in the memory management table 56.

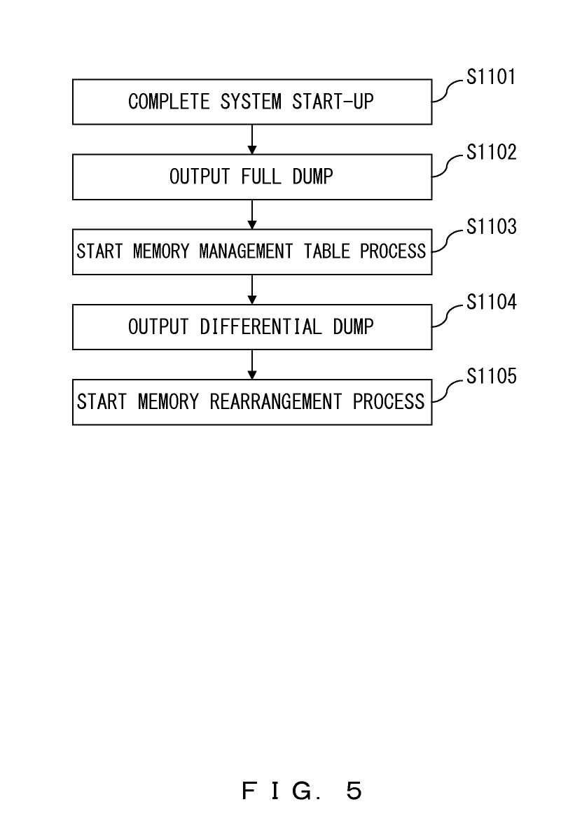

FIG. 5 illustrates a process flow of the information processing device 1 during OS operation.

After system start-up is completed (S1101), the dump obtaining unit 53 performs a full dump for outputting the contents of all of the regions in physical memory to an auxiliary storage device (S1102). After the full dump is finished, an operation of the memory management table 56 by the memory managing unit 55 is started (S1103). The contents of a memory region that has been updated following system operation are dumped at prescribed time intervals (S1104). Further, the memory managing unit 55 rearranges physical memory in accordance with an update frequency using information in the memory management table 56 (S1105).

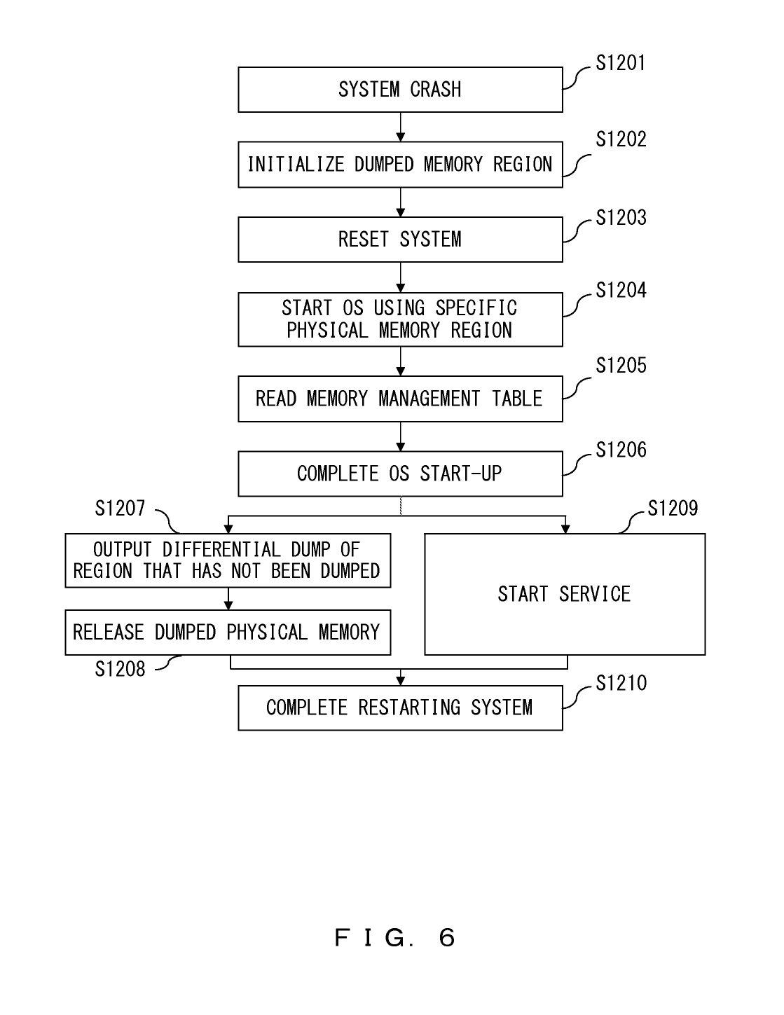

FIG. 6 illustrates a process flow of the information processing device 1 at the time of the occurrence of a serious error.

When a CPU detects an error, a system crash occurs (S1201), and a dumped memory region is initialized (S1202).

Next, a system reset is performed (S1203). When this happens, memory is not initialized.

Then, the OS is started using the memory region that has been initialized in S1202 (S1204).

Next, the memory management table 56 is read (S1205).

When OS start-up is completed (S1206), outputting a differential dump for a region that has not been dumped (S1207), releasing a dumped physical memory region (S1208), and starting a service (S1209) are performed in parallel. In outputting a differential dump for a region that has not been dumped, a region that has not been dumped is determined using the memory management table 56 that has been read in S1205. As outputting differential dumps for regions that have not been dumped proceeds, physical memory regions that have been dumped are sequentially released (S1208). When dumping of all of the physical memory regions at the time of the occurrence of a failure has been completed, the restart of the system is completed (S1210).

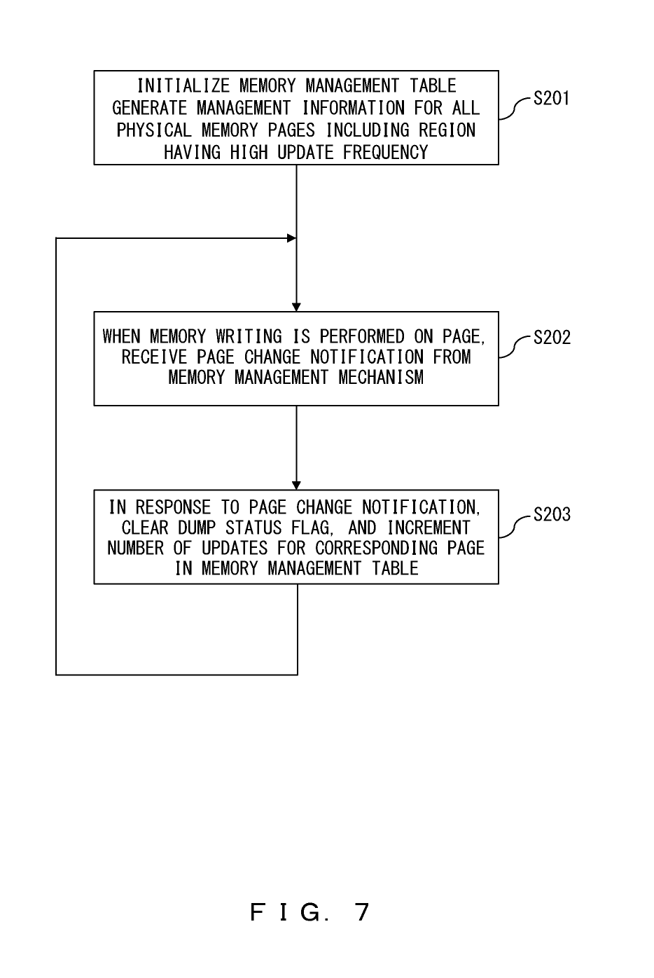

Described next are operations of the memory managing unit 55 and the memory management table 56 when a memory page is updated in regular operation. FIG. 7 is a diagram explaining the operations of the memory managing unit 55 and the memory management table 56 when a memory page is updated.

First, when operation of a system according to the embodiment is started, the memory managing unit 55 generates the memory management table 56 that includes management information of all of the memory pages configuring physical memory (S201). The item “page address” 904 in the memory management table 56 is generated so as to correspond to all of the pages in the physical memory installed in the system. Here, all the memory pages include memory region 3 having a high update frequency, in addition to memory region 1 and memory region 2. In addition, all values of “dump status” 905 are set to “1”, and all values of “number of updates” 906 are set to “0”.

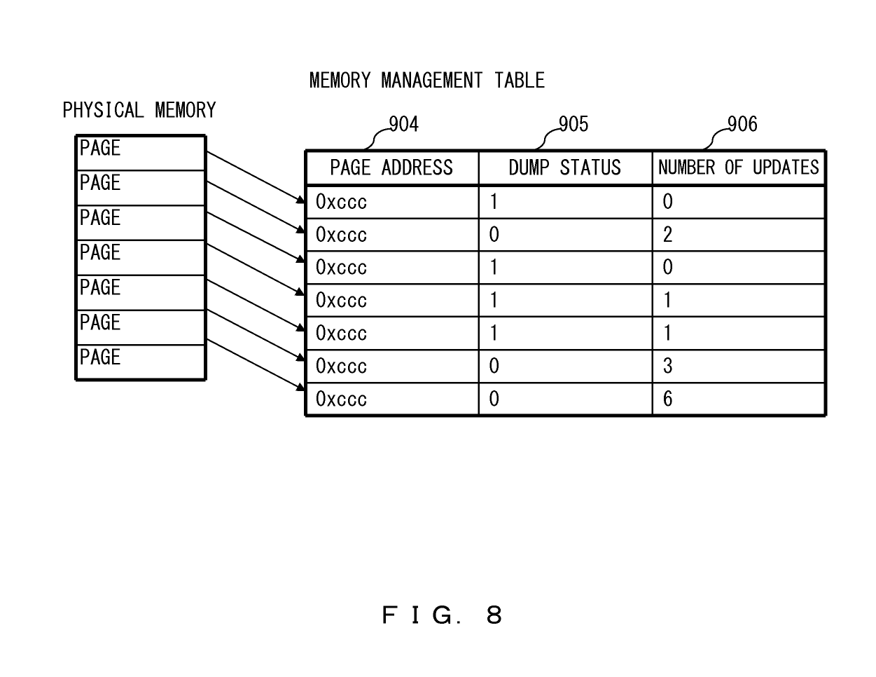

FIG. 8 is a diagram explaining that “page address” 904 in the memory management table 56 according to the embodiment corresponds to a memory page in physical memory. As illustrated in FIG. 8, page addresses are stored in “page address” 904 so as to correspond to all of the pages in physical memory.

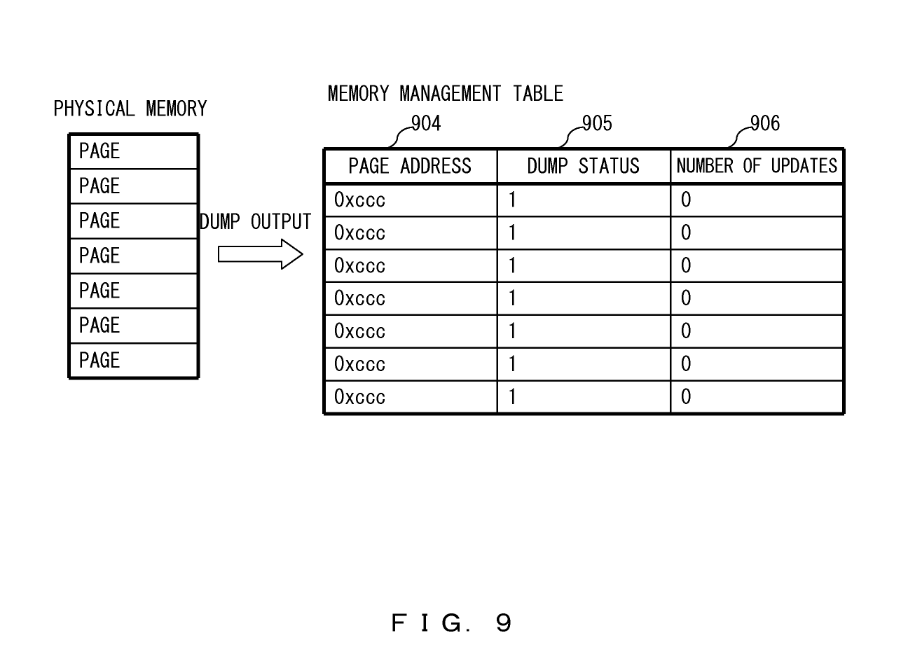

FIG. 9 illustrates a state of the memory management table 56 when performing a memory full dump (S1102) that is performed immediately after starting an OS when starting operation of a system according to the embodiment. Here, “1” is stored in “dump status” 905, and “0” is stored in “number of updates” 906 for all entries in the memory management table 56.

When writing is performed on a memory page in physical memory, the memory managing unit 55 receives a page change notification from the memory management mechanism 51 of the OS (S202). Upon receipt of the page change notification, the memory managing unit 55 changes a value of “dump status” 905 in the memory management table 56 that corresponds to a page indicated in the notification to “0”, and increments a value of “number of updates” 906 (S203).

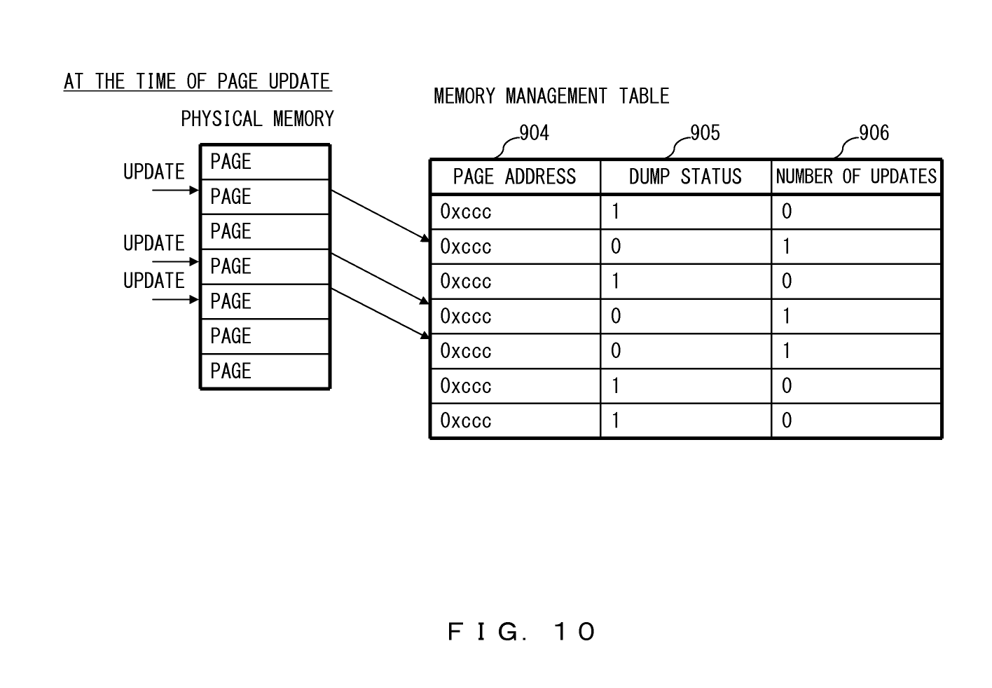

FIG. 10 illustrates a state of the memory management table 56 when updating a memory page. The memory managing unit 55 stores “0” in “dump status” 905 for an entry corresponding to an updated page, and increments a value of “number of updates” 906.

When the memory managing unit 55 updates the memory management table 56, the process moves on to S202.

A function of outputting a differential dump during OS operation is described next.

The dump obtaining unit 53 outputs a differential dump at prescribed time intervals. The dump obtaining unit 53 determines a region for which a differential dump is to be obtained, using the memory management table 56, and dumps only a memory region for which a differential dump has been determined to be obtained. In other words, the dump obtaining unit 53 refers to values of “dump status” 905 in the memory management table 56, and determines a memory page for which a value of “dump status” 905 is “0” to be a target of a differential dump. However, a differential update is not performed on a memory page that is arranged in memory region 3 having a high update frequency.

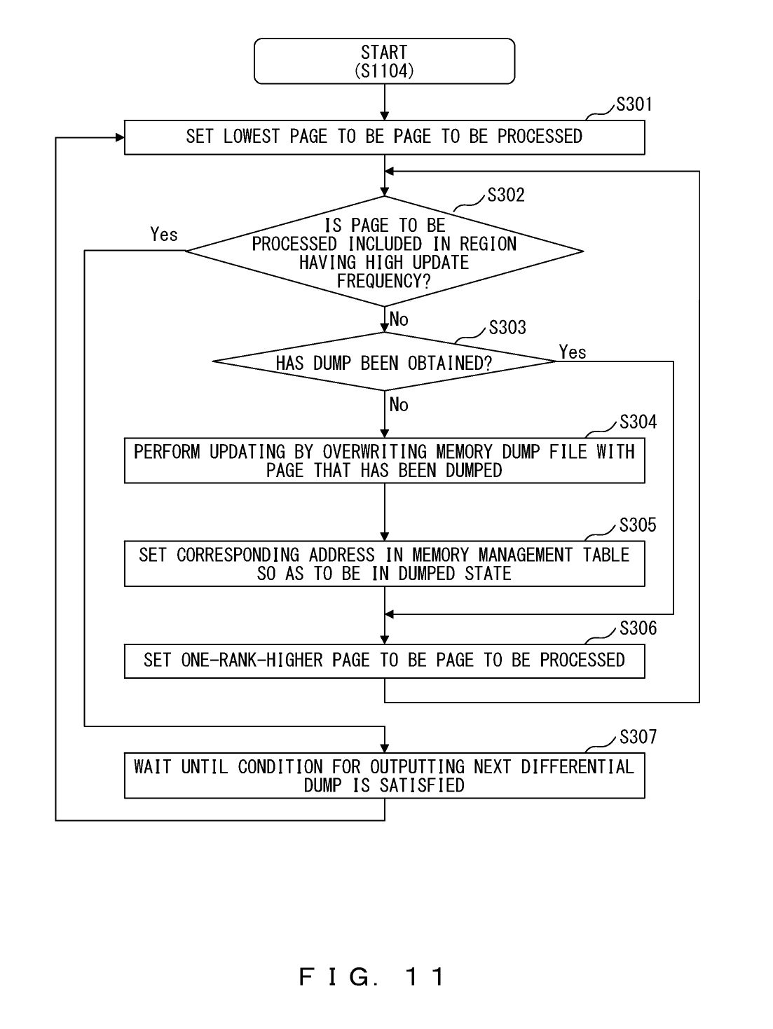

FIG. 11 illustrates an operation flow of a system when outputting a differential dump during OS operation. The flowchart of FIG. 11 illustrates details of the process of S1104 in FIG. 5.

In a differential dump output process, the processes of S302-S306 are performed for each page in ascending order of page addresses of physical memory. In other words, a single page is processed in one loop of S302-S306, and every time the process moves on to another loop, a page having a one-rank-higher address is processed.

First, in the differential dump output process, the dump obtaining unit 53 sets a page having the lowest address in physical memory to be a page to be processed (S301).

Then, the dump obtaining unit 53 determines whether a page being processed is a page included in a region having a high update frequency, i.e., memory region 3 (S302).

When a page being processed is included in a region having a high update frequency (“Yes” in S302), the process moves on to S307. When a page being processed is not included in a region having a high update frequency (“No” in S302), the dump obtaining unit 53 determines whether the page being processed has been dumped (S303). Here, the dump obtaining unit 53 uses the memory management table 56 to determine whether the page being processed has been dumped. In other words, the dump obtaining unit 53 refers to a value of “dump status” 905 for an entry in the memory management table 56 for which “page address” 904 matches an address of the page being processed, and determines whether the value of “dump status” 905 is “1”.

When the page being processed has been dumped (“Yes” in S303), the process moves on to S306. When the page being processed has not been dumped (“No” in S303), the dump obtaining unit 53 overwrites the dump file 57 on a disk with the contents of the page being processed that has not been dumped, and updates the dump file 57 (S304).

Then, the dump obtaining unit 53 sets the page being processed that has been dumped in S304 so as to be in a state in which a dump has been output. In other words, the dump obtaining unit 53 sets a value of “dump status” 905 to “1” for an entry in the memory management table 56 for which “page address” 904 matches an address of the page being processed (S305).

Then, a page to be processed shifts to a page having a one-rank-higher address than that of the page being processed (S306). The process then returns to S302.

When it is determined that a page that has been set in S301 so as to be processed is included in a region having a high update frequency, the system waits until a preset condition for outputting a subsequent differential dump is satisfied (S307). When the differential dump output condition is satisfied, the process returns to S301.

Examples of the differential dump output condition in S307 include a condition that a prescribed time period has passed, a condition that the number of updated pages has reached a prescribed number, or other conditions. Specifically, as an example, a prescribed time period (e.g., one minute) having passed after the system commences waiting in S307 is considered as the differential dump output condition. As another example, the number of updated memory pages having reached a prescribed number of pages or more (e.g., 1000 pages or more) after the system commences waiting in S307 is considered as the differential dump output condition.

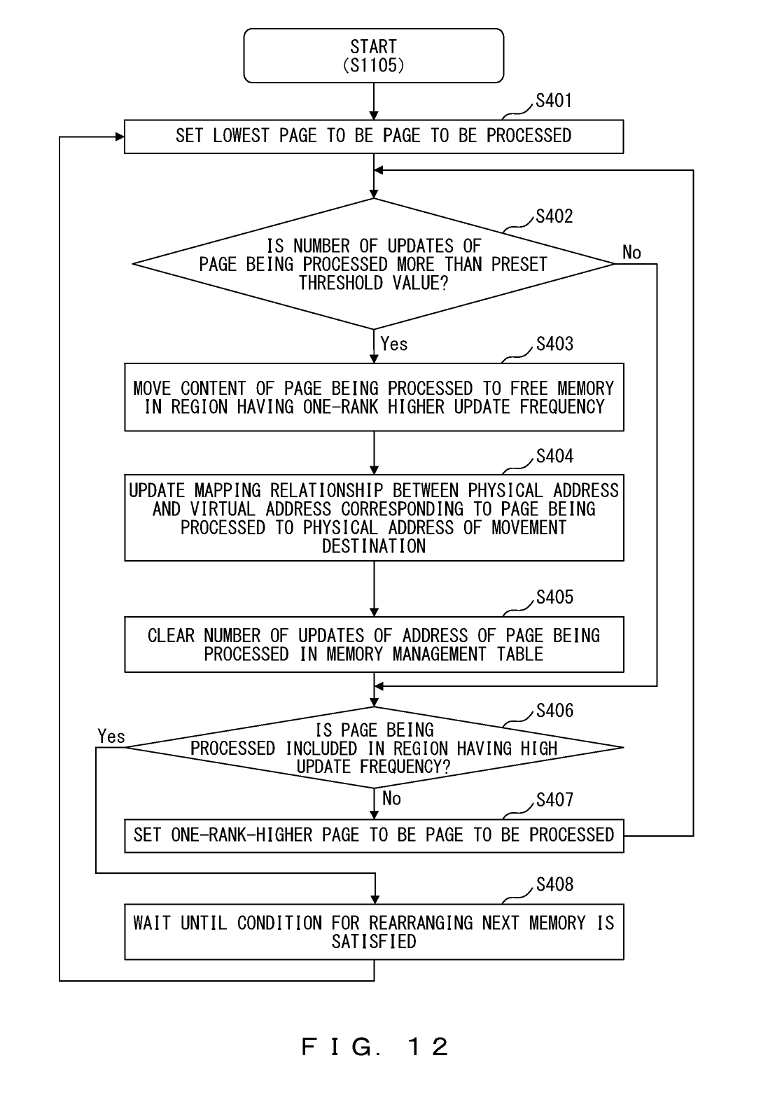

Next, an operation of rearranging physical memory in accordance with an update frequency of a memory page is described. FIG. 12 illustrates an operation flow of rearrangement of physical memory according to an update frequency of a memory page. The flowchart of FIG. 12 illustrates details of the process of S1105 in FIG. 5.

In a rearrangement process of physical memory, the processes of S402-S407 are performed for each page in the ascending order of addresses of the physical memory. In other words, a single page is processed in one loop of S402-S407, and every time the process moves on to another loop, a page having a one-rank-higher address is processed.

In the physical memory rearrangement process, the memory managing unit 55 first sets a page having the lowest address in physical memory to be a page to be processed (S401).

Then, the memory managing unit 55 checks whether the number of updates of a page being processed is more than a preset threshold value (S402). In other words, the memory managing unit 55 refers to a value of “number of updates” 906 for an entry in the memory management table 56 for which “page address” 904 matches an address of the page being processed, and determines whether the value of “number of updates” 906 is higher than a threshold value given in advance.

When the number of updates of a page being processed is not more than the threshold value (“No” in S402), the process moves on to S406. When the number of updates of a page being processed is more than the threshold value (“Yes” in S402), the memory managing unit 55 moves the contents of the page being processed to an unused region in a one-rank-higher memory region than a memory region classified in accordance with an update frequency (S403). In other words, when the page being processed is included in memory region 1, which has a low update frequency, the memory managing unit 55 moves the contents of the page being processed to free memory in memory region 2, which has a middle-level update frequency. When the page being processed is included in memory region 2, which has a middle-level update frequency, the memory managing unit 55 moves the contents of the page being processed to free memory in memory region 3, which has a high update frequency.

Next, the memory managing unit 55 updates a mapping relationship between a physical address and a virtual address of the system on the basis of a physical address of a movement destination (S404). In other words, the memory managing unit 55 changes a physical address corresponding to a virtual address of a page being processed from a physical address before the movement to a physical address after the movement.

Then, the memory managing unit 55 clears “number of updates” 906 for an address of the page being processed in the memory management table 56 (S405). In other words, the memory managing unit 55 changes a value of “number of updates” 906 to “0” for an entry in the memory management table 56 for which “page address” 904 matches an address of the page being processed.

Next, the memory managing unit 55 determines whether the page being processed is included in memory region 3, which is a region having a high update frequency (S406). When the page being processed is not included in a region having a high update frequency (“No” in S406), a page having a one-rank-higher address than that of the page being processed is set to be a page to be processed (S407). Then, the process moves on to S402.

When the page being processed is included in a region having a high update frequency (“Yes” in S406), the system waits until the next memory rearrangement condition (S408). Examples of the memory rearrangement condition in S408 include the passage of a prescribed time period or the like. Specifically, as an example, a prescribed time period (e.g., one minute) having passed after the system commences waiting in S408 is considered as the memory rearrangement condition.

When the memory rearrangement condition is satisfied, the process returns to S401.

When the number of updates of a page being processed is not more than the threshold value (“No” in S402), the process may move on to S405. In addition, similarly to the process in FIG. 12, the memory managing unit 55 may perform, on a page having an update frequency that is less than a prescribed threshold value (a threshold value that is different from the threshold value in S402), a process of moving the contents of the page to an unused region in a one-rank-lower memory region than a memory region classified in accordance with an update frequency.

Next, a process flow of a system after the occurrence of a serious error in a server before the completion of OS start-up is described in detail. The system control unit 54 restarts the system using only a dumped memory region (memory region 1) while maintaining the memory contents of a region that has not been dumped at the time of the occurrence of an error. Here, the system control unit 54 determines whether a memory region has been dumped, using the memory management table 56. A memory region used for storing the memory management table 56 is inherited even after restart while storing the memory contents without fail. Here, this does not apply to a case in which a storage region for the memory management table 56 is implemented on a device other than physical memory.

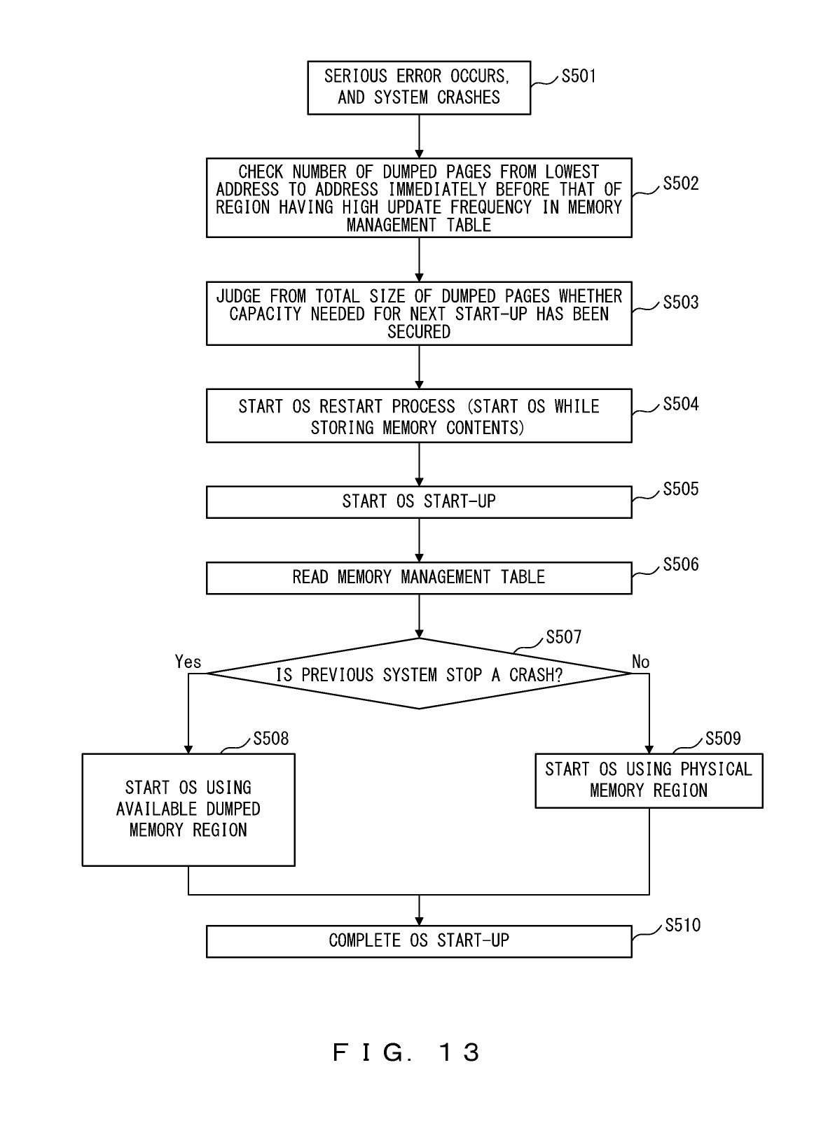

FIG. 13 illustrates a process flow of a system after a serious error occurs in a server before OS start-up is completed. The flowchart of FIG. 13 illustrates details of the processes of S1201-S1210 in FIG. 6.

When a serious error occurs in a system and a system crash occurs (S501), the system control unit 54 changes a value of “shut-down status” 903 in the memory management table 56 to “0”. Next, the system control unit 54 checks the number of dumped pages from the lowest address to an address immediately before that of a region having a high update frequency in the memory management table 56 (S502). Specifically, the system control unit 54 refers to values of “dump status” 905 of entries having page addresses from the lowest address to an address immediately before that of a region having a high update frequency in the memory management table 56, and calculates the number of pages for which the value of “dump status” 905 is “1”.

Next, the system control unit 54 determines from a total size of dumped pages, which has been calculated in S502, whether a capacity needed for the next start-up has been secured (S503). In other words, the system control unit 54 determines whether a total size of dumped pages, which has been calculated in S502, exceeds a capacity needed for the next start-up. When it is determined that a capacity needed for the next start-up has not been secured, the dump obtaining unit 53 performs a dump process until a capacity needed for start-up is secured.

Next, the system control unit 54 starts an OS restart process (S504). When OS start-up is started (S505), the system control unit 54 reads the memory management table 56 (S506). Then, the system control unit 54 refers to the memory management table 56, and determines whether a previous system stop is a crash (S507). Specifically, when the value of “shut-down status” 903 in the memory management table 56 is “0”, the system control unit 54 determines that a previous system stop is a crash, and when the value of “shut-down status” 903 in the memory management table 56 is “1”, the system control unit 54 determines that a previous system stop is not a crash. When the system control unit 54 determines that a previous system stop is a crash (“Yes” in S507), the system control unit 54 starts the OS using dumped memory regions (S508). Specifically, the system control unit 54 first releases memory regions for dumped pages, except a memory region in which the memory management table 56 has been stored. In other words, the system control unit 54 notifies the memory management mechanism 51 of the OS of dumped pages as available memory. Then, the system control unit 54 performs an OS start-up process using only the released memory regions. OS start-up is then completed (S510).

In S507, when the system control unit 54 determines that a previous system stop is not a crash (“No” in S507), the system control unit 54 starts the OS using a usual system start-up method (S509), and OS start-up is completed (S510).

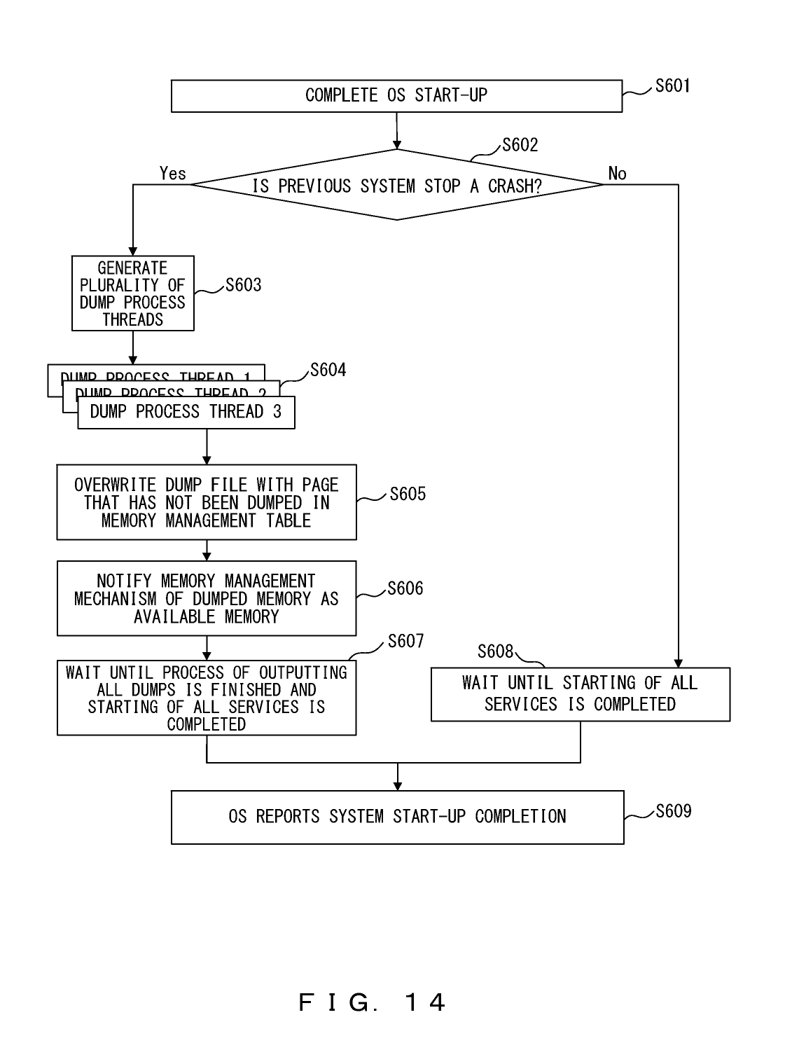

Next, an operation of dumping a memory page that has not been dumped with multiprocessing after OS start-up is described. FIG. 14 illustrates an operation flow of a system when dumping a memory page that has not been dumped with multiprocessing after OS start-up.

After OS start-up is completed (S601), the system control unit 54 refers to “shut-down status” 903 in the memory management table 56, and determines whether a previous system stop is a crash (S602). When a previous system stop is a crash (“Yes” in S602), the system control unit 54 generates a plurality of dump process threads (S603). The plurality of dump process threads generated in S603 perform the processes of S605-S607 in parallel. In S604, dump process thread 1, dump process thread 2, and dump process thread 3 are generated. In the description below, a plurality of dump process threads are collectively referred to as a “dump process thread”. A dump process thread is a thread configuring the dump obtaining unit 53.

A dump process thread refers to the memory management table 56 so as to determine a page that has not been dumped, and stores, in the dump file 57, the contents of the page that is determined not to have been dumped. Specifically, the dump process thread refers to “dump status” 905 for all of the entries in the memory management table 56, and obtains dumps of pages for which the value of “dump status” 905 is “0”. Then, the dump process thread registers in the memory management table 56 that a dump has been obtained. In other words, the dump process thread changes a value of “dump status” 905 corresponding to a dumped page to “1”.

Next, the dump process thread releases a memory page that has been dumped in S605. In other words, the dump process thread notifies the memory management mechanism 51 of the OS of the dumped memory page as available memory (S606).

When all of the dump output processes are finished, namely, when there are no entries for which the value of “dump status” 905 in the memory management table 56 is “0”, the dump process thread waits until start-up of all of the services is completed (S607).

When start-up of all of the services is completed, the OS notifies the system of the completion of system start-up (S609).

In S602, when it is determined that a previous system stop is not a crash (“No” in S602), system start-up is performed by means of a usual operation, and therefore the dump process thread waits until start-up of all of the services is completed (S608). Then, when start-up of all of the services is completed, the OS notifies the system of the completion of system start-up (S609).

By implementing functions of the dump obtaining unit 53 and the memory managing unit 55 on an OS, a dump obtaining function of the OS is strengthened, and a time needed to restart a service is shortened.

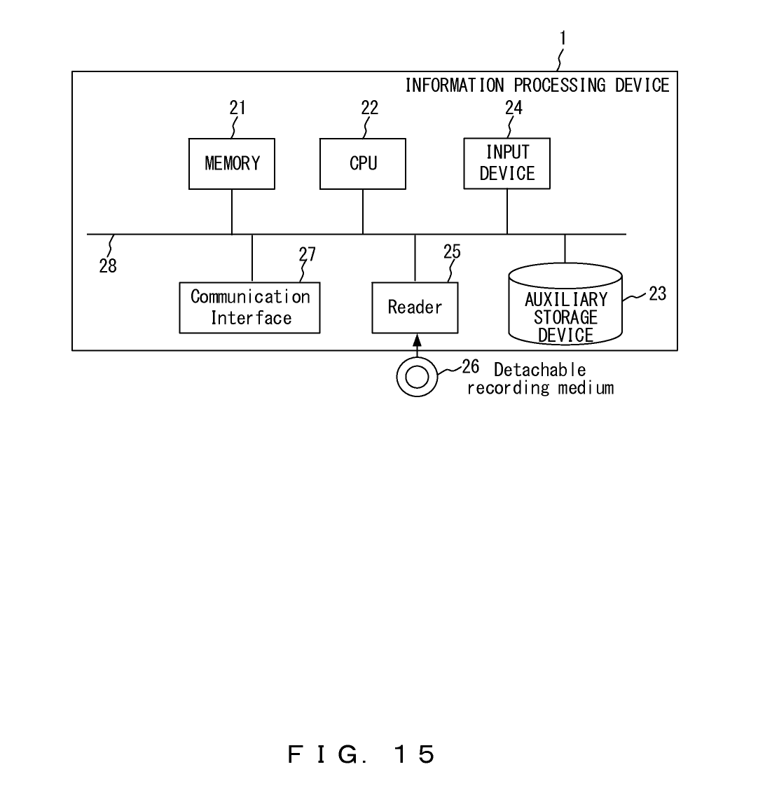

FIG. 15 illustrates an example of a hardware configuration of the information processing device 1 according to the embodiment.

The information processing device 1 includes a memory 21, a CPU 22, an auxiliary storage device 23, an input device 24, a reader 25, and a communication interface 27. In addition, the memory 21, the CPU 22, the auxiliary storage device 23, the input device 24, the reader 25, and the communication interface 27 are connected to each other via a bus 28, for example. An example of the CPU 22 is a processor.

The CPU 22 processes various operations by executing various programs that have been stored in the memory. Specifically, the CPU 22 performs functions of the first storing processing unit 5, the second storing processing unit 6, the detecting unit 7, the control unit 8, the managing unit 9, and the arranging unit 11. In other words, the CPU 22 performs functions of the memory managing unit 55, the system control unit 54, the dump obtaining unit 53, and the like.

In the memory 21, programs executed by the CPU 22 and pieces of data used by the programs are stored. Specifically, programs of the operating system 58, the dump obtaining unit 53, the system control unit 54, the memory managing unit 55 and the like are executed in the memory 21. In addition, the memory 21 is given as an example of the first storage unit 2, the storing completion information storing unit 4, or the update frequency information storing unit 10. The memory 21 is, for example, semiconductor memory, and is configured by including a RAM area and a ROM area.

In the auxiliary storage device 23, the dump file 57 in which the contents of the memory 21 have been stored is stored. The auxiliary storage device 23 is given as an example of the second storage unit. The auxiliary storage device 23 is, for example, a hard disk, and stores programs executed by the CPU 22 according to an embodiment of the present invention. The auxiliary storage device 23 may be semiconductor memory such as flash memory etc. The auxiliary storage device 23 may also be an external storage device.

In addition, the memory management table 56 may be stored in the memory 21, or may be stored in a prescribed region in the information processing device 1.

The input device 24 is used when a timing of obtaining a dump, a fixed region size for each update frequency of physical memory, or a threshold value of an update frequency is set by a user of the information processing device 1.

The reader 25 accesses a detachable recording medium 26 at an instruction of the CPU 22. The detachable recording medium 26 may be realized by a semiconductor device (USB memory etc.), a medium (magnetic disk etc.) to and from which information is input and output by a magnetic effect, a medium (CD-ROM, DVD, etc.) to and from which information is input and output by an optical effect, etc. The reader 25 is omissible.

The communication interface 27 communicates data over a network at an instruction from the CPU 22. The communication interface 27 is omissible.

The communication program according to an embodiment of the present invention is provided for the information processing device 1 in the following configuration, for example.

(1) Installed in advance in the auxiliary storage device 23.

(2) Provided by the detachable recording medium 26.

(3) Provided from a program server (not illustrated in the attached drawings) through the communication interface 27.

The present invention is not limited to the embodiment described above, and various configurations or embodiments can be employed without departing from the spirit of the present invention.

According to an aspect of the present invention, a dump time needed for system recovery can be shortened when a failure occurs in a system.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
a first storage unit that stores pieces of information that the information processing device uses;
a second storage unit that stores pieces of information stored in the first storage unit;
a storing completion information storing unit that stores storing completion information that discriminates information that has been stored in the second storage unit from among the pieces of information stored in the first storage unit; and
a processor that executes a process including:
when the information stored in the first storage unit is stored in the second storage unit, storing the storing completion information corresponding to the stored information in the storing completion information storing unit;
detecting a failure in the information processing device;
performing a restart process on the information processing device using a region in which the stored information has been stored in the first storage unit on the basis of the storing completion information when the failure is detected; and
discriminating information that has not been stored in the second storage unit from among the pieces of information stored in the first storage unit on the basis of the storing completion information when the failure is detected, and storing the discriminated information in the second storage unit.

2. The information processing device according to claim 1, the process further including:
when the information stored in the first storage unit is updated, storing the storing completion information corresponding to the updated information in the storing completion information storing unit.

3. The information processing device according to claim 2, wherein
the storing the discriminated information stores, in the second storage unit, information that has not been stored in the second storage unit from among the pieces of information stored in the first storage unit on the basis of the storing completion information at prescribed time intervals.

4. The information processing device according to claim 1, the information processing device further comprising:
an update frequency information storing unit that stores update frequency information indicating an update frequency for each storage region included in the first storage unit, wherein
the process further including:
when the information stored in the first storage unit is updated, updating the update frequency information corresponding to the storage region in which the updated information has been stored,
the storing the discriminated information stores, in the second storage unit, information stored in the storage region for which a value of the update frequency information is not more than a prescribed threshold value.

5. The information processing device according to claim 4, the process further including:
moving, in response to the update frequency information, the information stored in the storage region to a storage region in the first storage unit corresponding to the update frequency information.

6. A non-transitory computer-readable recording medium having stored therein a program for causing a computer to execute a process for storing information, the process comprising:
when information stored in a first storage unit that stores pieces of information that an information processing device uses is stored in a second storage unit that stores pieces of information stored in the first storage unit, storing storing completion information corresponding to the stored information in a storing completion information storing unit that stores storing completion information that discriminates information that has been stored in the second storage unit from among the pieces of information stored in the first storage unit;
detecting a failure in the information processing device;
performing a restart process on the information processing device using a region in the first storage unit in which the stored information was stored on the basis of the storing completion information when the failure is detected; and
discriminating information that has not been stored in the second storage unit from among the pieces of information stored in the first storage unit on the basis of the storing completion information when the failure is detected, and storing the discriminated information in the second storage unit.

7. The non-transitory computer-readable recording medium according to claim 6, the process further comprising:
when the information stored in the first storage unit is updated, storing the storing completion information corresponding to the updated information in the storing completion information storing unit.

8. The non-transitory computer-readable recording medium according to claim 7, wherein
the storing the discriminated information stores, in the second storage unit, information that has not been stored in the second storage unit from among the pieces of information stored in the first storage unit on the basis of the storing completion information at prescribed time intervals.

9. The non-transitory computer-readable recording medium according to claim 6, the process further comprising:
when the information stored in the first storage unit is updated, updating update frequency information corresponding to a storage region in which the updated information has been stored from among pieces of update frequency information that each indicate an update frequency for each of the storage regions included in the first storage unit, wherein
the storing the discriminated information stores, in the second storage unit, information stored in the storage region for which a value of the update frequency information is not more than a prescribed threshold value.

10. An information storing processing method performed by a computer, the information storing processing method comprising:
when information stored in a first storage unit that stores pieces of information that an information processing device uses is stored in a second storage unit that stores pieces of information stored in the first storage unit, storing storing completion information corresponding to the stored information in a storing completion information storing unit that stores pieces of storing completion information that discriminate information that has been stored in the second storage unit from among the pieces of information stored in the first storage unit;
detecting a failure in the information processing device;
performing a restart process on the information processing device using a region in the first storage unit in which the stored information was stored on the basis of the storing completion information when the failure is detected;
discriminating information that has not been stored in the second storage unit from among the pieces of information stored in the first storage unit on the basis of the storing completion information when the failure is detected; and
storing the discriminated information in the second storage unit.

11. The information storing processing method according to claim 10, the information storing processing method further comprising
when the information stored in the first storage unit is updated, storing the storing completion information corresponding to the updated information in the storing completion information storing unit.

12. The information storing processing method according to claim 11, wherein
the storing the discriminated information stores, in the second storage unit, information that has not been stored in the second storage unit from among the pieces of information stored in the first storage unit on the basis of the storing completion information at prescribed time intervals.

13. The information storing processing method according to claim 10, the information storing processing method further comprising:
when the information stored in the first storage unit is updated, updating update frequency information corresponding to a storage region in which the updated information has been stored from among pieces of update frequency information that each indicate an update frequency for each of the storage regions included in the first storage unit, wherein
the storing the discriminated information stores, in the second storage unit, information stored in the storage region for which a value of the update frequency information is not more than a prescribed threshold value.
